(19) United States
(12) Patent Application Publication
(10) Pub. No.: US 2022/0298065 A1
(43) Pub. Date: Sep. 22, 2022

(54) DECORATED GLASS SHEET AND MANUFACTURING METHOD THEREOF

(71) Applicant: OMNI DECOR S.R.L., Mosciano Sant'Angelo (Teramo) (IT)

(72) Inventor: Ferruccio BRESCIANI, Mosciano Sant'Angelo (Teramo) (IT)

(21) Appl. No.: 17/619,156

(22) PCT Filed: Jun. 19, 2020
(86) PCT No.: PCT/IB2020/055791

§ 371 Date: Dec. 14, 2021

(30) Foreign Application Priority Data
Jun. 21, 2019 (IT) 102019000009783

(51) Int. Cl. C03C 17/34; C03C 17/42

(52) U.S. Cl. CPC C03C 17/3405; C03C 17/3411; C03C 17/42; C03C 2217/72

(57) ABSTRACT

A decorated glass sheet comprising an essentially flat sheet body with a pair of opposite plane and parallel faces; in which a first face of the pair of faces of the sheet body has a satin finish, and in which a second face of the pair of faces is provided with:
at least one decorative layer made of one or more colored paints defining a non-uniform decorative pattern replicating the aspect of marble, and
a cover layer made from a substantially non-transparent colored paint, arranged above and in direct contact with the decorative layer so that the decorative layer is interposed between the sheet body and the cover layer.

### TECHNICAL FIELD

The present invention relates to a decorated glass sheet and to the manufacturing method thereof.

### BACKGROUND ART

Glass sheet or plane glass is a widely used material in various fields, for example in construction/architecture and in furnishing.

The need for new materials combining technical-functional features with unique appearances is strongly felt, particularly in these fields.

Although the use of decorated and/or colored glass in these applications is widespread, it is still limited by the effects which may be achieved, as well as by the physical-mechanical features of commercial glass.

There are available, in particular for covering walls, for example glass sheets colored by applying a layer of colored paint to a face of the glass sheet, in particular the face intended to be used to glue the sheet onto the wall to be covered (so-referred to as “face 2”: conventionally, in the field of plane glass, “face 1” is defined as that on the same side as the observer, while the opposite face is referred to as “face 2”).

The application of the paint aims at making the sheet colored, or in any case no longer transparent or translucent, to use it as a colored covering while keeping the increased surface gloss typical of a glass surface and simultaneously ensuring the color is not scratched or nicked (given that the color is on the face used for gluing to the wall).

Glass sheets of the type herein mentioned have excellent aesthetical features, given by the combination of the transparency of the glass and the color applied, and they keep such features for a long time. Therefore, they lend themselves to various applications in interior design, such as covering of doors of closets or kitchens, interior doors, tables, or for use as wall covering in commercial spaces.

However, the glass sheets herein indicated, and others of the known art which are substantially similar, appear to still have margins for improvement, in particular in terms of quality of the finishings and aesthetical effects which may be obtained, as well as of safety of use and versatility of employment.

### OBJECT OF THE INVENTION

It is the object of the present invention to provide a decorated glass sheet, and the related manufacturing method, which do not have the drawbacks herein noted of the known art.

In particular, it is an object of the invention to provide a glass sheet, available also in sheets of large sizes, which may be decorated with a high finishing quality and aesthetical effects using a simple and affordable industrial process.

According to such objects, the present invention relates to a glass sheet and to the manufacturing method thereof, as defined in essential terms in the appended independent claims, as well as for the additional preferred features in the dependent claims.

Thus, the invention provides decorated glass sheets, also of large sizes, which may be used, for example as covering, while maintaining the decorative state in “face 2”, thus protected in use from possible damage and deterioration because obtained on the inner face of the glass sheet, which is used for gluing to the covered wall.

The invention allows particular finishings and aesthetical effects to be obtained, in particular a marble aspect, with high quality and replicating the aspect of the original natural material, not only the aspect (by printing specific designs reproducing the veins of marble), but also the surface aspect, using a satin finish treatment on “face 1”. This treatment gives the decorative layer a “blurry” effect which causes it to resemble a natural marble surface.

The tactile and visual sensation given by the satin finish in conjunction with the visual perception of the decorative layer replicating marble advantageously allows an impression of marble to be evoked in the observer.

The synergistic effect of the application of a decorative layer and of a protective layer to face 2 and of the surface processing of face 1 allows a decorated glass sheet with high quality to be obtained.

The observer looking at face 1 of the decorated glass sheet of the present invention thus perceives the glass sheet itself as a marble sheet.

Indeed, the satin finish obtained on face 1 advantageously allows the non-uniform decorative pattern replicating the marble aspect obtained by applying a decorative layer to face 2 to be “blurred”, giving the glass sheet the aesthetical and tactile appearance of a marble sheet.

Therefore, using a decorated glass sheet according to the present invention advantageously allows the same aesthetical and tactile effect of a marble sheet to be achieved in an effective and affordable manner.

Advantageously, the base glass used for making the glass sheets of the invention is a glass of the “extra clear” type, i.e. particularly white in color due to the very low or almost zero quantity of iron oxides in the compound mixture of the glass itself.

The particularly white color of the glass, without a main color, allows a result which is very faithful to the color of the paint used, to be obtained on “face 1”, without the interference of the green color usually in the “float” glass of regular production obtained with a sodium-calcium composition which may contain iron oxides responsible for the main green color.

The glass sheets of the invention have various applications, for example in interior design, such as covering of doors of closets or kitchens, interior doors, tables, or for use as wall covering in commercial spaces.

In any case, further applications are possible: for example, glass sheets with higher thicknesses (indicatively 8, 10 and 12 mm) are adapted to make shelves and tabletops.

The glass sheets of the invention are advantageously provided in large sizes, indicatively with a width of 3210 mm (standard width for manufacturing plane glass in Europe) and a length of 2000 mm to 2600 mm.

In order to be used in covering furnishing objects such as furniture, partition walls, doors of kitchens, etc., the above-indicated glass sheets in large sizes are to be cut and processed peripherally with a grinding of the edge for aesthetical and safety reasons. The glass sheets of the invention are completely suitable for these successive processing operations, without resulting in any deterioration of the aesthetical features of the finished product.

### BRIEF DESCRIPTION OF THE DRAWINGS

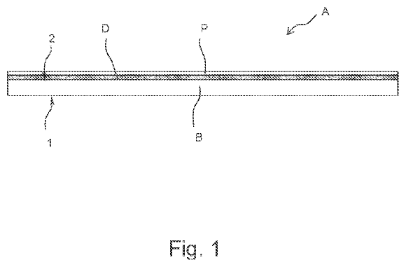

Further features and advantages of the present invention will become more apparent from the following description of a non-limiting embodiment thereof, with reference to accompanying FIG. 1, which shows, out of scale, a diagrammatic side view of a glass sheet obtained according to the invention.

### DETAILED DESCRIPTION OF PREFERRED EMBODIMENTS OF THE INVENTION

A decorated plane glass sheet according to the present invention is indicated with A in the accompanying drawing.

Sheet A defines a “face 1” adapted to face, in use, the users/observers of sheet A, and a “face 2”, opposite to “face 1”, adapted to face, in coupled use with, an outer support surface, for example a wall (if sheet A is used for wall covering) or a surface of a piece of furniture or other furnishing element.

For example, sheet A has sizes from 3210×2000 mm to 3210×2600 mm, and a thickness between 4 and 12 mm.

It is understood that sheet A may have different sizes from those herein indicated by mere way of example.

The sizes indicated are those resulting from the transport need of the glass sheets themselves from the manufacturing factory or second processing at the final transformation market.

Manufacturing glass sheets indeed occurs in large primary factories, from which the sheets are then distributed to the transformation market, transporting them according to two different methods and size types: in crates or in jumbo sheets; in any case, the sheets are transported using at most the load and size capacity of transport vehicles. When transported in crates, the maximum measurement is 2600×3210 mm.

Sheet A comprises an essentially flat sheet body B with a pair of opposite plane and parallel faces 1, 2.

Advantageously, a first face 1 of the pair of faces 1, 2 of the sheet body B has a satin finish.

In particular, the first face 1 defines the face 1 of sheet A and therefore is adapted to face, in use, the users/observers of sheet A. In other words, the outer surface of the sheet body B at the first face 1 is subjected to a satin finish process which gives the face 1 of sheet A itself a satin finish.

In particular, the sheet body B is an unstratified monolithic body, and sheet A comprises a single layer of glass consisting of the sheet body B.

The sheet body B is preferably made of an extra-clear glass with low or reduced content of iron oxides so as to have a light transmission of at least 90% and preferably of at least 91%. It is in any case understood that the sheet body B may also be made of another type of glass, for example a clear glass.

A second face 2 of the pair of faces 1, 2, opposite to the first face 1, is advantageously provided with at least one decorative layer D made of one or more colored paints defining a non-uniform decorative pattern replicating the aspect of marble. In other words, the decorative layer D replicating the design/pattern of marble is directly applied on the second face 2 of the sheet body B.

Therefore, face 2, which is visible from face 1 through the sheet body B, is a marbled surface which has the aspect of marble.

In particular, the non-uniform decorative pattern may also be regular (i.e. consisting of units which are repeated in one or more directions), but it has designs or patterns and is not simply a uniform colored layer.

Advantageously, the second face 2 is further provided with a cover layer P located above layer D and in direct contact with layer D. In other words, the decorative layer D is interposed between the sheet body B and the cover layer P.

In other embodiments not illustrated in the accompanying drawings, the face 2 of sheet A is provided with a plurality of decorative layers D overlapping one another to form the desired decorative pattern, each layer D being made from one or more, possibly different colored paints and having its own design or decoration.

Also depending on the subsequent safety needs of the finished product and/or of the technology used for applying paints to the glass sheet, in order to obtain the layer (or layers) D, water-soluble paints (i.e. water-based) of the following types may be used:
organic paints based on water-soluble organic resins;
inorganic paints based on colored inorganic ceramic enamels;
mixed organic-inorganic paints, comprising mixtures of inorganic ceramic enamels and organic resins (in particular polyester resins).

Organic paints (consisting of water-soluble organic resins) have resistance to temperature not higher than 120 to 130° C. and are applied, for example by means of one of the following techniques: screen printing, spraying, ink-jet printing.

Inorganic paints are based on inorganic ceramic enamels for glass of various type, also not containing ceramic frit (and which therefore would not be adapted to use on glass sublayers alone). In general, these paints require a first drying at temperatures of about 100° C. and a subsequent final curing which occurs at higher temperatures, indicatively higher than 600° C., in particular 620° C. or higher.

Mixed paints consist of mixtures of inorganic ceramic enamels (which may or may not contain ceramic frit) and organic resins (for example, polyester resins) serving the function of ensuring an optimal adhesion of the ceramic enamels themselves to the glass. In general, these paints require a first drying at temperatures of about 120 to 150° C. and a subsequent final curing which occurs at higher temperatures, indicatively higher than 600° C., in particular 620° C. or higher.

It is to be noted that enamels for use on glass differ from those used on ceramic surfaces, such as tiles, sanitary fittings, decorative objects, vases, etc.

The composition of enamels “for glass” are indeed characterized by the presence of particles of the so-called “ceramic frit”, which consists of clear glass granules in addition to mineral pigments which are characteristic of enamel. By melting at a curing temperature higher than and close to 620° C., these glass granules incorporate and set the colored pigments to the surface of the glass, thus creating an “enameled” surface.

Layer D is advantageously made by a screen-printing process, i.e. with screen-printing machines, which in addition to ensuring increased productivity, also allow the pattern on the glass sheet to be easily changed. Moreover, screen-printing machines may easily apply colors having different composition, in general both organic and inorganic type colors.

An ink-jet printing technique adapted to the use of the paints employed may also be used for applying layer D (or layers D, if more than one).

Once the paint in liquid form is applied, layer D (or each of the layers D) is subjected to a flash-off step, indicatively of 5 to 15 minutes, for example of about 10 minutes; and to a step of drying in furnace, for example in an infrared radiation furnace, at about 150° C. for 15 to 20 minutes. Clearly, the operating parameters of the flash-off and drying steps may vary also according to the paints used.

Once the spreading of the layer or layers D is complete, possibly with various colors or different designs, layer P is applied above layer D (or of the last of the layers D, if more than one). Clearly, if there are several decorative layers D, the first decorative layer D (innermost) is in direct contact with the glass of the second face 2, and the cover layer P is in direct contact with the last (outermost) of the layers D.

Advantageously, layer P firstly serves the function of decorative cover because it acts as colored background to the decoration obtained with the underlying layer or layers D, making the glass completely non-transparent to light and obtaining the decorative effect by virtue of the contrast in color with the underlying layer or layers D.

Therefore, for this purpose layer D is made from a substantially non-transparent colored paint.

A second function of layer P, particularly if the underlying layer D is made from mixed organic/inorganic paints, is that of covering the underlying layer or layers D with a layer consisting of ceramic glass enamels, thus also containing “ceramic frit” particles.

If the glass is subjected to high temperatures, higher than 580° C., as occurs for example during the glass bending or tempering processes, by melting, the ceramic frit in layer P sets not only layer P itself, but also the underlying decorative layer or layers D to the glass surface. Therefore, all layers applied will be highly gripped to the glass surface.

The application of layer P is preferably obtained by spraying an inorganic paint or a mixed organic/inorganic paint of the above-indicated types, after applying the decorative layer or layers D.

In any case, other methods of industrial application may also be used for applying layer P, using for example dull glazing machines, roller application machines, screen-printing machines, ink-jet printing machines, etc.

The cover layer P is then flashed off and dried with methods similar to those provided for the application of the decorative layer D.

The aspect of the surface of sheet A thus treated on face 2 is uniform, without variations of thickness, and aesthetically pleasing because it has the aspect of an “enameled” surface.

To obtain a marble-effect surface (which replicates the aspect of marble), the face 1 of sheet A (opposite to face 2 which is provided with the decorative layer or layers D and with the cover layer P) is subjected to a satin finish treatment so as to provide the face 1 of sheet A with an (outer) surface with a satin finish. Thereby, the decorative layer (D) takes a “blurred” effect which causes it to resemble a natural marble surface.

Finally, it is understood that further modifications and variants may be made to the glass sheet and manufacturing method thereof described and shown herein, which do not depart from the scope of the appended claims.

1. A decorated glass sheet comprising an essentially flat sheet body with a pair of opposite plane and parallel faces; wherein a first face of said pair of faces of the sheet body has a satin finish, and wherein a second face of said pair of faces is provided with:
at least one decorative layer made of one or more colored paints defining a non-uniform decorative pattern replicating the aspect of marble, and
a cover layer made from a substantially non-transparent colored paint, arranged above and in direct contact with said decorative layer so that said at least one decorative layer is interposed between the sheet body and the cover layer.

2. A glass sheet according to claim 1, having a width of about 3210 mm, and a length between about 2000 mm and about 2600 mm, and a thickness between about 4 and about 12 mm.

3. A glass sheet according to claim 1, wherein the decorative layer is made of one or more water-soluble paints selected from the group consisting of: organic paints based on water-soluble organic resins; inorganic paints based on colored inorganic ceramic enamels; mixed organic-inorganic paints comprising mixtures of inorganic ceramic enamels and organic resins.

4. A glass sheet according to claim 1, wherein the decorative layer is made, at least in part, of a paint containing one or more polyester resins.

5. A glass sheet according to claim 1, wherein the decorative layer is made, at least in part, of a paint comprising one or more enamels for glass, containing or not containing ceramic frit particles.

6. A glass sheet according to claim 1, wherein the cover layer is made of a paint comprising one or more ceramic glass enamels containing ceramic frit particles.

7. A glass sheet according to claim 1, wherein the cover layer is made of an inorganic paint or a mixed organic/inorganic paint.

8. A glass sheet according to claim 1, wherein the sheet body is made of an extra-clear glass with low or reduced content of iron oxides and having a light transmission of at least 90% and preferably of at least 91%.

9. A method for manufacturing a decorated glass sheet, comprising the steps of:
preparing an essentially flat glass sheet body having a pair of opposite plane and parallel faces,
obtaining a satin finish of the first face of said pair of faces of the sheet body,
applying to a second face of said pair of faces, opposite to said first face, at least one decorative layer of paint made of one or more colored paints defining a non-uniform decorative pattern replicating the aspect of marble,
applying a cover layer to and in direct contact with said decorative layer, the cover layer being made from a substantially non-transparent colored paint so that said at least one decorative layer is interposed between the sheet body and the cover layer.

10. A method according to claim 9, wherein the glass sheet is manufactured to have a width of about 3210 mm, and a length between about 2000 mm and about 2600 mm, and a thickness between about 4 and about 12 mm.

11. A method according to claim 9, wherein the decorative layer is made of one or more water-soluble paints selected from the group consisting of: organic paints based on water-soluble organic resins; inorganic paints based on colored inorganic ceramic enamels; mixed organic-inorganic paints comprising mixtures of inorganic ceramic enamels and organic resins.

12. A method according to claim 9, wherein the decorative layer is made, at least in part, of a paint containing one or more polyester resins.

13. A method according to claim 9, wherein the decorative layer is made, at least in part, of a paint comprising one or more enamels for glass, containing or not containing ceramic frit particles.

14. A method according to claim 9, wherein the cover layer is made of a paint comprising one or more ceramic glass enamels containing ceramic frit particles.

15. A method according to claim 9, wherein the cover layer is made of an inorganic paint or a mixed organic/inorganic paint.

16. A method according to claim 9, wherein the sheet body is made of an extra-clear glass with low or reduced content of iron oxides and having a light transmission of at least 90% and preferably of at least 91%.

17. A method according to one claim 9, comprising a step of flashing off the decorative layer and a subsequent drying step.

18. A method according to claim 9, comprising a step of flashing off the cover layer and a subsequent drying step.

19. A method according to claim 9, herein the decorative layer is made by a screen-printing process or an ink-jet printing process.
